(19) United States
(12) Patent Application Publication
(10) Pub. No.: US 2026/0097732 A1
(43) Pub. Date: Apr. 9, 2026

(54) BUMPER ASSEMBLY

(71) Applicant: NISSAN NORTH AMERICA, INC., Franklin, TN (US)

(72) Inventor: Diego Armando SALINAS CEBALLOS, Toluca (MX)

(21) Appl. No.: 18/911,227

(22) Filed: Oct. 9, 2024

(51) Int. Cl. B60R 19/24; B60R 19/52; B62D 35/00

(52) U.S. Cl. CPC B60R 19/24; B60R 19/52; B62D 35/007

(57) ABSTRACT

A vehicle includes a vehicle rear panel and a bumper assembly. The bumper assembly has a rear fascia installed to the vehicle rear panel and an energy transfer member sandwiched between the rear fascia and the vehicle rear panel. The energy transfer member has an energy receiving portion and an energy dispersing portion. The energy receiving portion includes a rearward attachment surface of the energy transfer member that faces the rear fascia. The energy dispersing portion includes a forward attachment surface of the energy transfer member that faces the vehicle rear panel. The energy dispersing portion includes a forward attachment surface of the energy transfer member that faces the vehicle rear panel. The forward attachment surface has a maximum surface area and a maximum thickness that is less than a maximum surface area and a maximum thickness of the rearward attachment surface.

### BACKGROUND

### Technical Field

The present disclosure generally relates to a bumper assembly. More specifically, the present disclosure relates to a bumper assembly having an energy transfer member.

### Background Information

Front and rear bumper cores are typically made from Expanded Polypropylene. The front and rear bumpers are the first point of contact when a vehicle is involved in an impact. Expanded Polypropylene foam can be provided as part of a core of a front or rear bumper assembly to provide high-impact shock absorption capabilities.

### SUMMARY

In view of the state of the known technology, one aspect of the present disclosure is to provide a vehicle comprising a vehicle rear panel and a bumper assembly. The bumper assembly has a rear fascia installed to the vehicle rear panel and an energy transfer member sandwiched between the rear fascia and the vehicle rear panel. The energy transfer member has an energy receiving portion and an energy dispersing portion. The energy receiving portion includes a rearward attachment surface of the energy transfer member that faces the rear fascia. The energy dispersing portion includes a forward attachment surface of the energy transfer member that faces the vehicle rear panel. The forward attachment surface has a maximum surface area and a maximum thickness that is less than a maximum surface area and a maximum thickness of the rearward attachment surface.

### BRIEF DESCRIPTION OF THE DRAWINGS

Referring now to the attached drawings which form a part of this original disclosure:

FIG. 1 is a rear perspective view of a vehicle equipped with a bumper assembly in accordance with an illustrated embodiment;

FIG. 2 is a front exploded view of the bumper assembly of FIG. 1;

FIG. 3 is a rear exploded view of the bumper assembly of FIGS. 1 and 2;

FIG. 4 is a side exploded view of the bumper assembly of FIGS. 1 to 3;

FIG. 5 is a side elevational view of the bumper assembly of FIGS. 1 to 4;

FIG. 6 is a side elevational view similar to FIG. 5 but with an energy absorption member of the bumper assembly in a deformed state;

FIG. 7 is a perspective view of the energy absorption member;

FIG. 8 is an elevational view of a forward attachment surface of the energy absorption member; and

FIG. 9 is a side elevational view of the energy absorption member.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

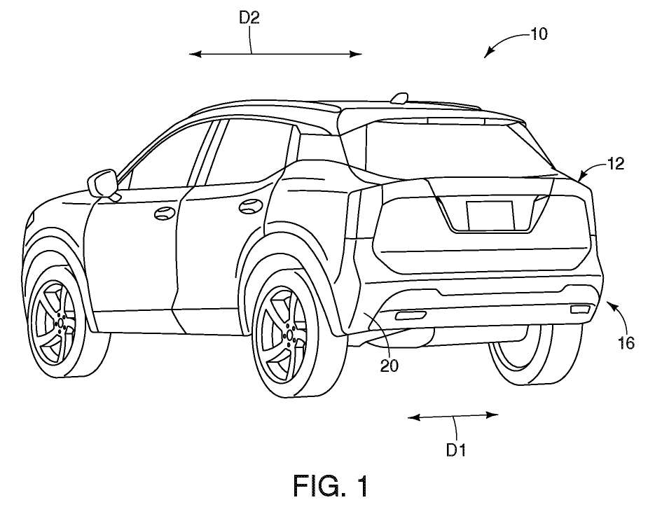

Referring initially to FIGS. 1 to 3, a vehicle 10 comprises a vehicle body 12 that is equipped with a vehicle rear panel 14 and a bumper assembly 16. The vehicle 10 comprises the rear panel 14 and the bumper assembly 16. The vehicle body 12 includes the rear panel 14 and a floor panel 18. The rear panel 14 is assembled to the floor panel 18. The rear panel 14 and the floor panel 18 are part of the vehicle’s 10 inner body panels. The rear panel 14 and the floor panel 18 are large sheet metals form part of the vehicle’s body. During assembly, a sealant (e.g., caulk) is applied along a seam between a rear end 18a of the floor panel 18 and the rear panel 14 to prevent air leakage from the vehicle interior or water intrusion to the vehicle interior.

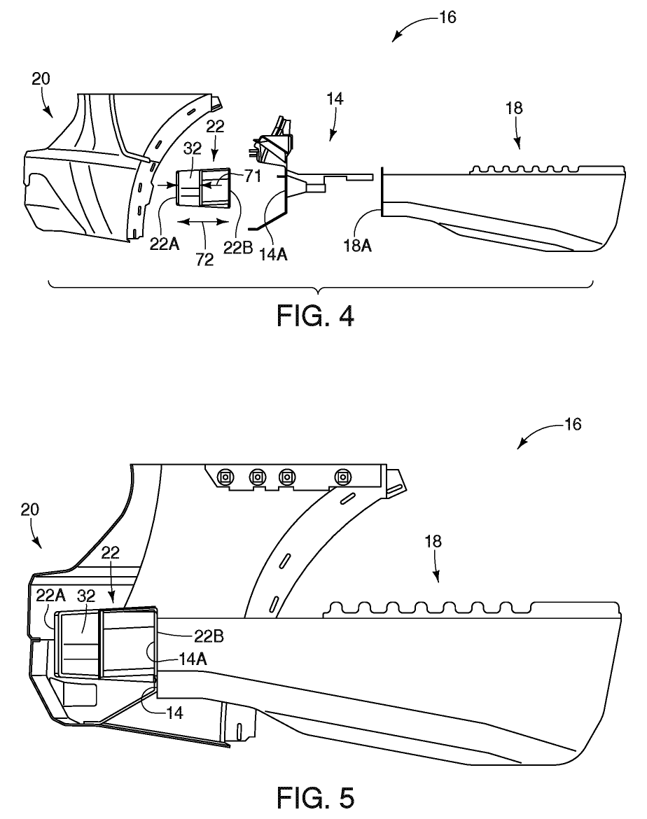

As best seen in FIGS. 4 and 5, the bumper assembly 16 is assembled to the rear panel 14. The bumper assembly 16 has a rear fascia 20 and an energy transfer member 22 sandwiched between the rear fascia 20 and the rear panel 14. The rear fascia 20 is alternatively known as a bumper cover that is installed to the rear panel 14 to define a lower part of the vehicle body. The rear fascia 20 is provided to protect the vehicle body 12 during a rear-end impact. The rear fascia 20 can be made of plastic, resin or steel. The bumper assembly 16 having the energy absorption member is provided to effectively absorb and disperse kinetic energy received from a rear end impact.

In particular, the energy transfer member 22 of the illustrated embodiment is provided to dissipate kinetic energy to the rear panel 14 at an attachment area of the rear panel 14. The energy transfer member 22 of the illustrated embodiment also deforms upon receiving impact as will be further described below. In this way, the energy transfer member 22 absorbs kinetic energy while dissipating the kinetic energy to the rear panel 14 at the attachment area with the rear panel 14 in a controlled manner such that shock is directed to a small area of the rear panel 14 and not transferred throughout the rear panel 14.

Preferably, the energy transfer member 22 is installed directly to the rear panel 14 and directly abuts the rear fascia 20. The energy transfer member 22 of the illustrated embodiment is made of expanded polypropylene and preferably has a density of at least approximately thirty (30) grams per liter. In comparison to conventional energy transfer members, the energy transfer of the illustrated embodiment has a density of approximately of at least 30 grams per liter whereas conventional energy transfer members have a density of approximately 20 grams per liter.

The energy transfer member 22 of the illustrated embodiment has a geometry including a T-shaped attachment area 24 that contacts the rear panel 14. The energy transfer member 22 of the illustrated embodiment is configured such that a front end of the energy transfer member 22 has a smaller surface area than a rear end of the energy transfer member 22 in order to focus the kinetic energy that is transferred to the rear panel 14 resulting from impact, as will be further described below. The combination of the geometry and the density of the energy transfer member 22 enables the energy transfer member 22 of the illustrated embodiment to absorb energy and also to transfer kinetic energy in a controlled manner to a corresponding attachment area 14A of the rear panel 14. The corresponding attachment area 14A of the rear panel 14 contacts the T-shaped attachment area 24 of the energy transfer member 22 to receive kinetic energy from the energy transfer member 22.

The energy transfer member 22 includes an energy receiving portion 22A defining the rear end R of the energy transfer member 22. The energy transfer member 22 includes an energy dispersing portion 22B defining the front end of the energy transfer member 22. As best seen in FIGS. 2, 4 and 9, the energy dispersing portion 22B includes a forward attachment surface 30 of the energy transfer member 22 that faces the vehicle rear panel 14. The attachment area includes the forward attachment surface 30. The energy receiving portion 22A includes a rearward attachment surface 31 that has a larger surface area than the forward attachment surface 30.

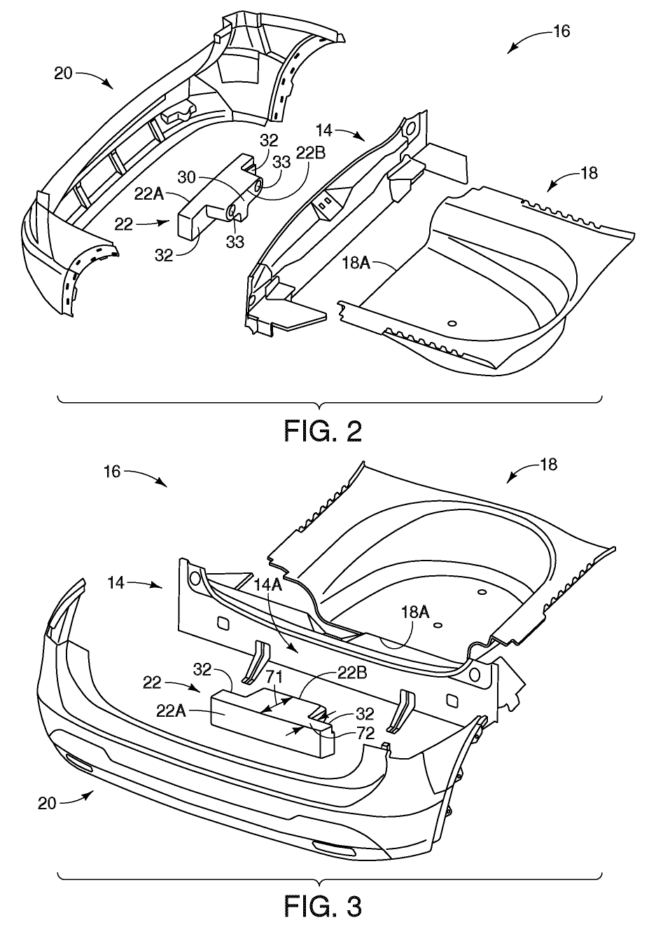

As seen in FIGS. 2 and 3, the forward attachment surface 30 abuts a center portion of the rear panel 14 in a widthwise direction D1. The forward attachment surface 30 is spaced from the lateral sides of the rear panel 14 in the vehicle widthwise direction D1. In the illustrated embodiment, the term “widthwise” or “lateral” refers to a vehicle width direction that extends from a drivers side to a passenger side of the vehicle and is perpendicular to a vehicle longitudinal or lengthwise direction D2.

With this configuration, the energy transfer member 22 enables a smaller attachment area between the energy transfer member 22 and the rear panel 14. Therefore, the forward attachment surface 30 has a maximum width that is less than a maximum width of the rearward attachment surface 31 so that the energy dispersing portion 22B deforms prior to the energy receiving portion 22A when the rear fascia 20 receives an impact. In this way, impact or kinetic energy is not dispersed laterally of the rear panel 14 that is susceptible to creating cracks between the rear panel 14 and the floor panel 18. Alternatively speaking, the energy receiving portion 22A transfers energy to an area of the rear panel 14 that is when the rear fascia 20 receives an impact.

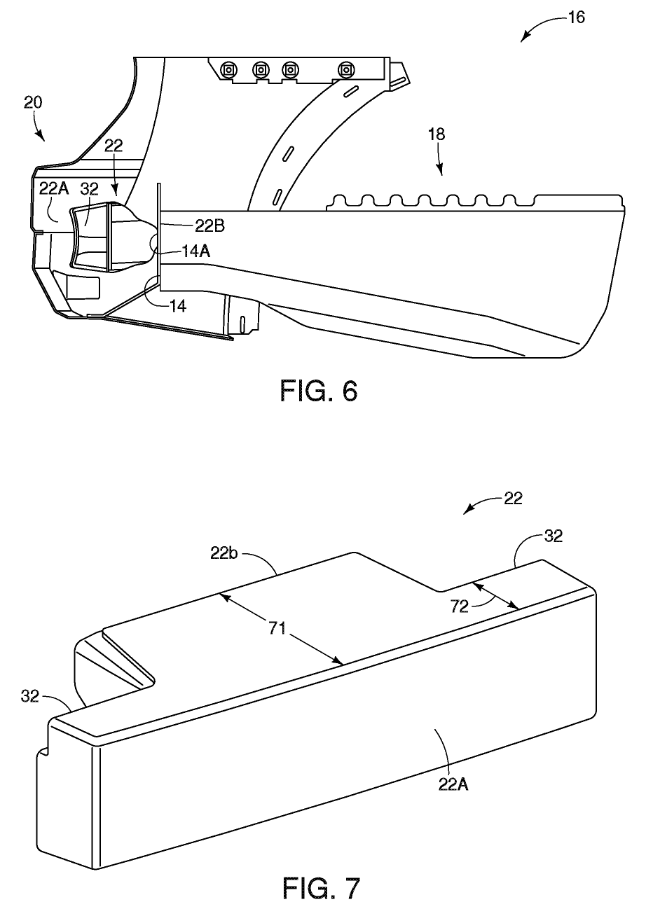

As best seen in FIG. 6, the energy dispersing portion 22B has a first thickness T1 that is part of a thickest part of the energy transfer member 22. Therefore, the portion of the energy dispersing portion 22B having the T-shaped attachment area 24 has the first thickness T1. As seen in FIGS. 6, 8 and 9, the energy receiving portion 22A has a pair of wings 32 having a second thickness T2 that is less than the first thickness T1. The wings 32 extend laterally with respect to the T-shaped attachment area 24 in the vehicle widthwise direction D1.

Referring to FIGS. 2, 3 and 8, the forward attachment surface 30 has a pair of attachment openings 33 to be aligned with fasteners of the rear panel 14. That is, the attachment area of the energy receiving portion 22A includes attachment openings 33 that align with fasteners of the rear panel 14. Preferably, the fasteners are panel studs (not shown) of the rear panel 14 that are received by the attachment openings 33 to secure the energy transfer member 22 to the rear panel 14.

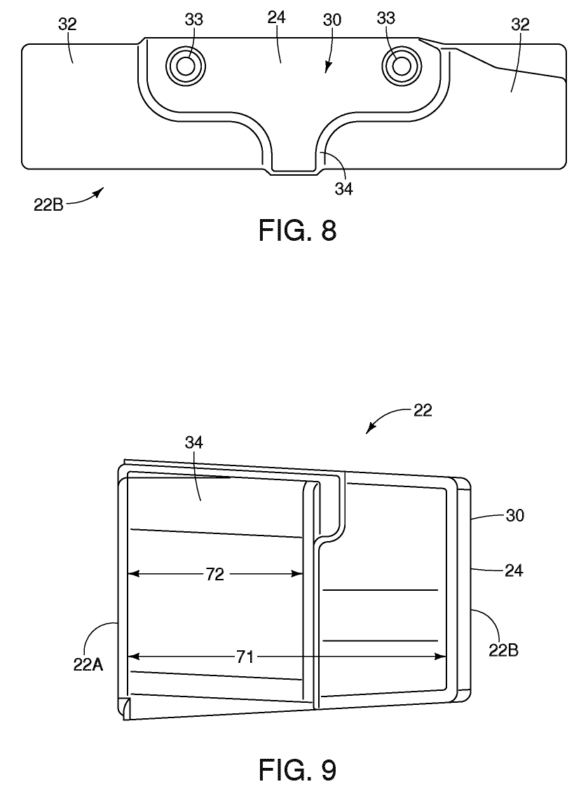

As best seen in FIG. 8, the forward attachment surface 30 includes an anti-rotation projection 34 that extends horizontally below and laterally between the pair of attachment openings 33. Therefore, the anti-rotation projection 34 extends offset of and at an angle with respect to the attachment openings 33. As shown, the forward attachment surface 30 is T-shaped with the anti-rotation projection 34 extending below the attachment openings 33 when the energy transfer member 22 is installed to the rear panel 14. The anti-rotation projection 34 is provided to anchor the energy transfer member 22 to the rear panel 14. That is, the anti-rotation projection 34 is provided to prevent rotation of the energy transfer member 22 with respect to the rear panel 14 and to maintain the orientation of the energy transfer member 22 with respect to the rear panel 14. In particular, the anti-rotation projection 34 is provided to prevent rotation of the energy transfer member 22 towards the vehicle widthwise or lateral direction.

As stated, the energy dispersing portion 22B is provided to deform prior to the wings 32 when the rear fascia 20 receives the impact to transfer and absorb energy from the rear fascia 20. That is, the energy dispersing portion 22B is configured to collapse or crush upon receiving impact, as seen in FIG. 6. The wings 32 are configured to bend towards the forward direction upon receiving impact. The wings 32 have the second thickness T2. As best seen in FIG. 5, the wings 32 are spaced from the rear panel 14 in a vehicle rearward direction when the energy transfer member 22 is installed to the rear panel 14. As seen in FIG. 6, the energy dispersing portion 22B and the wings 32 are deformable towards a vehicle forward direction when the rear fascia 20 receives the impact.

As seen in FIGS. 2 to 4, the energy receiving portion 22A includes the rearward attachment surface 31 of the energy transfer member 22 that faces the rear fascia 20. As stated, the energy receiving portion 22A defines the rear end of the energy transfer member 22. The energy receiving portion 22A has the wings 32 having the second thickness T2 that is less than the first thickness T1. As best seen in FIG. 7, the energy receiving portion 22A is preferably rectangular shaped. That is, the rearward attachment surface 31 is preferably rectangular shaped. However, it will be apparent to those skilled in the vehicle field from this disclosure that the energy receiving portion 22A can include inclines, projections or cutouts to accommodate the installation space as needed or desired.

The rearward attachment surface 31 has a larger surface area than the forward attachment surface 30. In this way, the energy transfer member 22 transfer absorbs energy by deforming and channeling energy from a larger surface area (the rearward attachment surface) to a smaller surface area (the forward attachment surface) such that the rear panel 14 only receives energy at the corresponding attachment surface and not a greater surface area. In the illustrated embodiment, the forward attachment surface 30 has a maximum surface area and a maximum thickness that is less than a maximum surface area and a maximum thickness of the rearward attachment surface 31.

Preferably, the rear attachment surface has a surface area that is approximately 3.5 times a surface area of the forward attachment surface. In particular, the surface area of the forward attachment surface 30 is approximately 16,000 to 16,500 square millimeters. That is, the attachment area of the energy transfer member 22 is approximately 16,000 to 16,500 square millimeters. The corresponding attachment area 14A of the rear panel 14 is approximately 16,000 to 16,5000 square millimeters. More preferably, the attachment area of the energy transfer member 22 is approximately 16,300 square millimeters. More preferably, the corresponding attachment area 14A of the rear panel 14 is approximately 16,300 square millimeters.

In understanding the scope of the present invention, the term “comprising” and its derivatives, as used herein, are intended to be open ended terms that specify the presence of the stated features, elements, components, or groups, but do not exclude the presence of other unstated features, elements, components, or groups. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the bumper assembly. Accordingly, these terms, as utilized to describe the present invention should be interpreted relative to a vehicle equipped with the bumper assembly.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle comprising:
a vehicle rear panel; and
a bumper assembly having a rear fascia installed to the vehicle rear panel and an energy transfer member sandwiched between the rear fascia and the vehicle rear panel, the energy transfer member having
an energy receiving portion including a rearward attachment surface of the energy transfer member that faces the rear fascia, and
an energy dispersing portion including a forward attachment surface of the energy transfer member that faces the vehicle rear panel, the forward attachment surface having a maximum surface area and a maximum thickness that is less than a maximum surface area and a maximum thickness of the rearward attachment surface.

2. The vehicle according to claim 1, wherein
the forward attachment surface of the energy dispersing portion has a pair of attachment openings to be aligned with fasteners of the rear panel, the forward attachment surface further has an anti-rotation projection extending offset of and at an angle with respect to the attachment openings.

3. The vehicle according to claim 2, wherein
the forward attachment surface is T-shaped with the anti-rotation projection extending below the attachment openings when the energy transfer member is installed to the rear panel.

4. The vehicle according to claim 1, wherein
the forward attachment surface abuts a center portion of the rear panel and is spaced from lateral sides of the rear panel in a vehicle lateral direction.

5. The vehicle according to claim 4, wherein
the energy dispersing portion has a first thickness, the energy receiving portion has a pair of wings having a second thickness that is less than the first thickness.

6. The vehicle according to claim 5, wherein
the wings are spaced from the rear panel in a vehicle rearward direction when the energy transfer member is installed to the rear panel.

7. The vehicle according to claim 6, wherein
the energy dispersing portion and the wings are deformable towards a vehicle forward direction when the rear fascia receives the impact.

8. The vehicle according to claim 7, wherein
the energy dispersing portion deforms prior to the wings when the rear fascia receives the impact.

9. The vehicle according to claim 3, wherein
the forward attachment surface abuts a center portion of the rear panel and is spaced from lateral sides of the rear panel.

10. The vehicle according to claim 9, wherein
the energy dispersing portion is T-shaped having a first thickness, the energy receiving portion has a pair of wings having a second thickness that is less than the first thickness.

11. The vehicle according to claim 10, wherein
the wings are spaced from the rear panel in a vehicle rearward direction when the energy transfer member is installed to the rear panel.

12. The vehicle according to claim 11, wherein
the energy dispersing portion and the wings are deformable when the rear fascia receives the impact.

13. The vehicle according to claim 12, wherein
the energy dispersing portion deforms prior to the wings when the rear fascia receives the impact.

14. The vehicle according to claim 1, wherein
the energy transfer member is made of expanded polypropylene having a density of at least 30 grams per liter.

15. The vehicle according to claim 14, wherein
the forward attachment surface of the energy dispersing portion has a pair of attachment openings to be aligned with fasteners of the rear panel, the forward attachment surface further has an anti-rotation projection extending offset of and at an angle with respect to the attachment openings.

16. The vehicle according to claim 15, wherein
the forward attachment surface is T-shaped with the anti-rotation projection extending below the attachment openings when the energy transfer member is installed to the rear panel.

17. A vehicle comprising:
a vehicle rear panel; and
a bumper assembly having a rear fascia installed to the vehicle rear panel and an energy transfer member sandwiched between the rear fascia and the vehicle rear panel, the energy transfer member having
an energy receiving portion including a rearward attachment surface of the energy transfer member that faces the rear fascia, and
an energy dispersing portion including a forward attachment surface of the energy transfer member that faces the vehicle rear panel, the forward attachment surface having a maximum surface area that is less than a maximum surface area of the rearward attachment surface so that the energy receiving portion transfers energy to an area of the rear panel that is laterally centered when the rear fascia receives an impact.
